(19) United States
(12) Patent Application Publication
(10) Pub. No.: US 2007/0267871 A1
(43) Pub. Date: Nov. 22, 2007

(54) Energy Myzer Hybrid Generator

(76) Inventor: Todd Michael Gregory, Petersburg, VA (US)

Correspondence Address: Todd M. Gregory, 124 Seyler Dr., Petersburg, VA, 23805, US

(21) Appl. No.: 11/713,775

(22) Filed: Mar. 5, 2007

Related U.S. Application Data
(60) Provisional application No. 60/801,110, filed on May 18, 2006.

(51) Int. Cl. F02N 11/04

(52) U.S. Cl. 290/33

(57) ABSTRACT

The importance and nature of this invention is to save fuel. The cost of gasoline is on the rise, and saving fuel is important to most people, companies and the environment.

### BACKGROUND OF THE INVENTION

The Energy Myzer Hybrid Generator is designed to be used were any other portable would be used, it could be used on construction work sites, it would very effective for home power outages, also would be would also be good for some off the grid applications were no power is available. The system would be very effective after catastrophic events like tornadoes and hurricanes when efficient low cost electricity would be a critical factor for normal living conditions.

### BRIEF SUMMARY OF THE INVENTION

The Energy Myzer control system is digital electronic and uses Ne555 cips in most control circuits this helps make the system very user friendly, these systems also make it very fuel efficient. More time to use your electric devices could only be an advantage.

### DETAILED DESCRIPTION OF “THE ENERGY MYZER HYBRID GENERATOR”

The Energy Myzer Generator is very similar to todays Hybrid automobiles. The electric gas powered generator saves high amounts of gas while it is not running and electric power is being supplied from a battery storage system. The complete system works as follows: The system has a cycle of electric power usage and battery charging due to a drop in voltage. The cycle starts with the batteries fully charged. The batteries used in the working prototype are 12V car starting batteries(two).

When the batteries are fully charged the 12 Vs are connected to a inverter that changes the 12 VDC into 110 VAC so that it can be used to run home type electric devices (TVs, computers etc. . . . ). The length of the battery storage part of cycle depends on the wattage rating of the devices being used. The higher the wattage being used the shorter the time of the battery usage. The batteries fully charged are about 13V, when they drop below about 12 Vs the batteries are automatically switched from the inverter to the charging system. This starts the second part of the cycle. The charging part of the cycle is more complex. The voltage drop of the batteries is noticed by a digital low voltage cut off circuit, this circuit controls relays that start the generator (via solenoid control of the starter motor). The same voltage that is used to turn on the starter motor is used to turn on a cold start circuit, this circuit has an electric fuel pump that delivers a low pressure fuel to an injector that delivers the sprayed fuel to the intake manifold of the generator so that it can it can start completely by electric control. Once the generator is started part of the generators voltage is used to stop the starter motor and cold start circuit via a relay. Also with relay control the battery charger gets 110 VAC from the generator to charge the batteries. The battery charger is a computerized “Smart Battery Charger”, this battery charger type had to be used in this system because it fully charges the batteries in the shortest amount of time saving more fuel . Also at the start the generator 12 VDC is supplied to a digital programmer circuit that is used to program the battery charger to its fastest charge rate (40 amp).Also note that the electric devices were being used on the inverter battery part of the system are automatically switched to the generator so that the generator can take its load so the batteries can charge at a faster rate. Also the rate of a full charge for the batteries is approximately 1 hour 15 minutes, so the system has been designed with a digital timer circuit that shuts off the generator at that time period. When the generator shuts off the load goes back to the inverter with out any shut off of power to the devices being used. At this point a complete cycle is done the batteries are fully charged and the system resets it self automatically. As long as fuel is in the generators tank the system will repeat the cycle, until it is shut off manually by shutting off power to the low voltage cut off circuit, and to the inverter circuit. The batteries and inverter and all of the electronic control system and battery charger are located in a cell that is attached on top the generator. It can be removed for maintenance. The complete system is on wheels and has handles so that the user can move the unit around (completely portable).

1. The one claim of this invention is that the Energy Myzer Hybrid Generator is more fuel efficient than gas generators that do not use batteries to store electricity. The storage system does give the the user free time that can be used to power electric devices. The system does allow the generators fuel to last longer.
